(19) United States
(12) Patent Application Publication
(10) Pub. No.: US 2015/0302360 A1
(43) Pub. Date: Oct. 22, 2015

(54) SYSTEMS AND METHODS OF AUTOMATIC ACCOUNTING OF LEAVE LIABILITY

(71) Applicant: Xero Limited, San Francisco, CA (US)

(72) Inventors: Stuart McLeod, Mill Valley, CA (US); John Freeman, Mill Valley, CA (US)

(21) Appl. No.: 14/693,198

(22) Filed: Apr. 22, 2015

Related U.S. Application Data
(63) Continuation of application No. 14/254,218, filed on Apr. 16, 2014.

(51) Int. Cl. G06Q 10/10; G06Q 40/00

(52) U.S. Cl. CPC G06Q 10/1057; G06Q 40/12

(57) ABSTRACT

Systems and methods of automatic accounting of leave liability are provided. Employee information associated with a first time period is accessed. The employee information relates to a first paid time off balance of an employee associated with the employee information. A first leave liability associated with the first time period is calculated using the employee information. The first leave liability is a first value relating to the first paid time off balance associated with the first time period. A difference between the first leave liability and a previous leave liability posted to a general ledger is determined. The previous leave liability relates to a previous paid time off balance associated with a previous time period. An adjustment reflecting the difference between the first leave liability and the previous leave liability is posted to the general ledger.

### CLAIM OF PRIORITY

This application is a continuation of and claims the benefit of priority to U.S. patent application Ser. No. 14/254,218, filed Apr. 16, 2014, the entire content of which is hereby incorporated by reference.

### TECHNICAL FIELD

The present disclosure generally relates to maintaining a general ledger and, more specifically, to systems and methods of automatic accounting of leave liability.

### BACKGROUND

A general ledger maintained by a business organization may operate as a central repository for accounting data, such as assets, liabilities, ownership equity, revenue, expenses, gains, losses, and the like. The general ledger may be used to track accounting data to ensure that the general ledger is balanced. To ensure that the general ledger is balanced, the following accounting equation is maintained: Assets=Liabilities+Ownership Equity. This accounting equation is the mathematical structure of a business organization's balance sheet, which may be a summary of financial balances of the business organization. The balance sheet may indicate assets, liabilities, and ownership equity of the business organization as of a specified date, such as the end of a financial quarter for example.

### BRIEF DESCRIPTION OF THE DRAWINGS

Some embodiments are illustrated by way of example and not of limitation in the figures of the accompanying drawings.

FIG. 1 is a schematic diagram showing an example of a system for automatic accounting of leave liability, according to some embodiments;

FIG. 2 is a block diagram showing example components of a payroll module, according to some embodiments;

FIGS. 3A and 3B are tables showing example data used to calculate leave liability, according to some embodiments;

FIG. 4 is a flowchart of an example method for automatic accounting of leave liability, according to some embodiments; and

FIG. 5 is a block diagram of a machine in the example form of a computer system within which a set of instructions, for causing the machine to perform any one or more of the methodologies discussed herein, may be executed, according to some embodiments.

### DETAILED DESCRIPTION

Example systems and methods of automatic accounting of leave liability are described. In the following description, for purposes of explanation, numerous specific details are set forth in order to provide a thorough understanding of example embodiments. It will be evident, however, to one skilled in the art, that the present technology may be practiced without these specific details.

A business organization may provide its employees with paid time off (PTO), which may also be referred to as leave. An employee may maintain and/or accrue leave in any manner specified by an employer. For example, an employee's leave may accrue based on an anniversary date (e.g., a start date of the employee), per hour, per pay period, and the like. The rate at which an employee may accrue leave may be any rate specified by the employer. For example, an employee may accrue 2.3 hours of leave per week such that the employee receives approximately 3 weeks of leave per year of employment.

Leave is stated on a business organization's balance sheet as a liability. The leave liability stated on the balance sheet must, by law, be stated based on an employee's current pay rate (e.g., the employee's pay rate as of the date of the balance sheet). However, the balance sheet leave liability may not accurately reflect the true leave liability for an employee if the employee's pay rate has changed while leave was accrued. For example, if Employee A accrues 1 hour of leave per week of employment, the true liability for each week of leave that is accrued is Employee A's pay rate during the week that Employee A accrued the hour of leave, as shown in the table below:

| | Hours | Value of Leave | Actual Leave | Leave Liability |
|---|---|---|---|---|
| Week | Accrued | Accrued | Liability | for Balance Sheet |
| 1 | 1 hour | $20 | $20 | $20 |
| 2 | 1 hour | $20 | $40 | $40 |
| 3 | 1 hour | $25 | $65 | $75 |
| 4 | 1 hour | $25 | $90 | $100 |

In week 1, Employee A accrues 1 hour of leave, which is valued at Employee A's pay rate of $20/hour. At the end of week 1, the actual leave liability would be $20, which is equal to the leave liability that would be stated on the balance sheet at the end of week 1 (e.g., 1 hour*$20/hour pay rate). At the end of week 2, Employee A will have received another hour of leave, making the actual leave liability and the liability to be stated on the balance sheet $40. However, in week 3, Employee A receives a pay raise to a pay rate of $25/hour. Thus at the end of week 3, the actual leave liability for Employee A is $65 ($20+$20+$25). However, at the end of week 3, the leave liability to be stated on the balance sheet is $75 (e.g., 3 hours*the current pay rate of $25/hour). This statement of leave liability may be inaccurately reflected in the general ledger.

To accurately reflect the leave liability for employees of a business organization, a journal entry may be automatically provided to a general ledger such that the journal entry reflects leave liability that accounts for changes in employee pay rates and leave balances. A payroll module may determine and store leave liability for each employee periodically (e.g., for each pay period), and the leave liability may be reflected in a journal entry provided to the general ledger periodically.

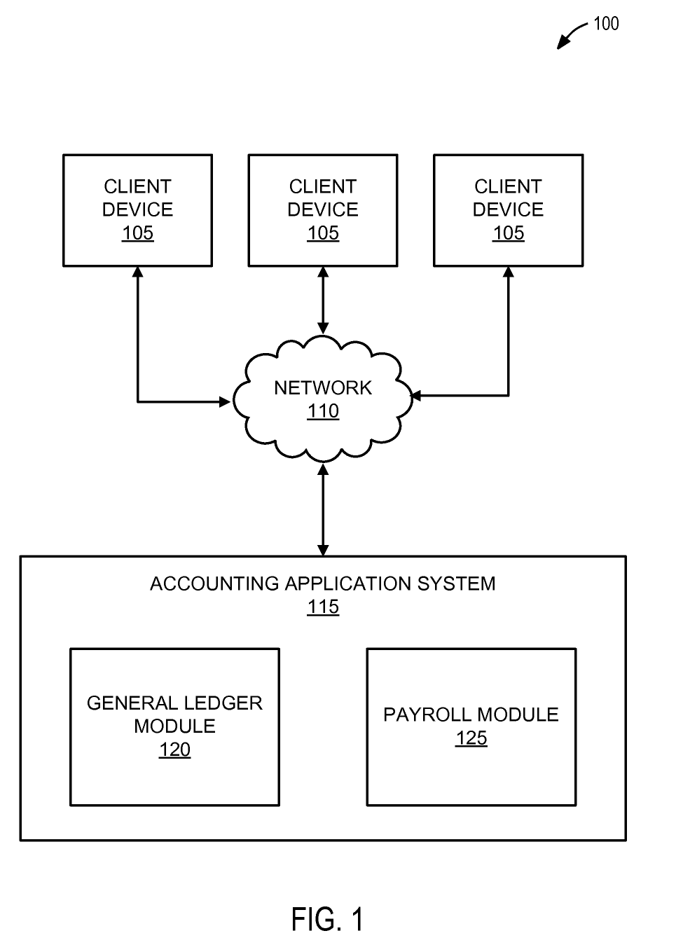

FIG. 1 is a schematic diagram showing an example of a system 100 for automatic accounting of leave liability. In some embodiments, the system 100 may include one or more client devices 105 in communication with an accounting application system 115. The client devices 105 may be connected to the accounting application system 115 directly or over a network 110, which may be any suitable network. In various embodiments, one or more portions of the network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or any other type of network, or a combination of two or more such networks.

The client device 105 may be any suitable computing device, such as a smart phone, a personal digital assistant, a mobile phone, a personal computer, a laptop, a computing tablet, or any other computing device suitable for accessing the accounting application system 115.

The accounting application system 115 may include a network-addressable computing system (or systems) that can provide any number of accounting-related features for one or more business organizations. The accounting application system 115 includes a general ledger module 120 and a payroll module 125. The general ledger module 120 provides a platform for controlling, managing, inputting, and viewing data in a general ledger for a business organization.

The general ledger module 120 may be a hardware-implemented module that may manage and control accounting data, such as assets, liabilities, ownership equity, revenue, expenses, gains, losses, and the like. The accounting data may be controlled, managed, inputted, and viewed using the client device 105.

The payroll module 125 of the accounting application system 115 may be a hardware-implemented module that may provide a platform for controlling, managing, inputting, and viewing payroll-related data relating to payroll functions of a business organization, such as leave liability data. The payroll-related data may be controlled, managed, inputted, and viewed using the client device 105.

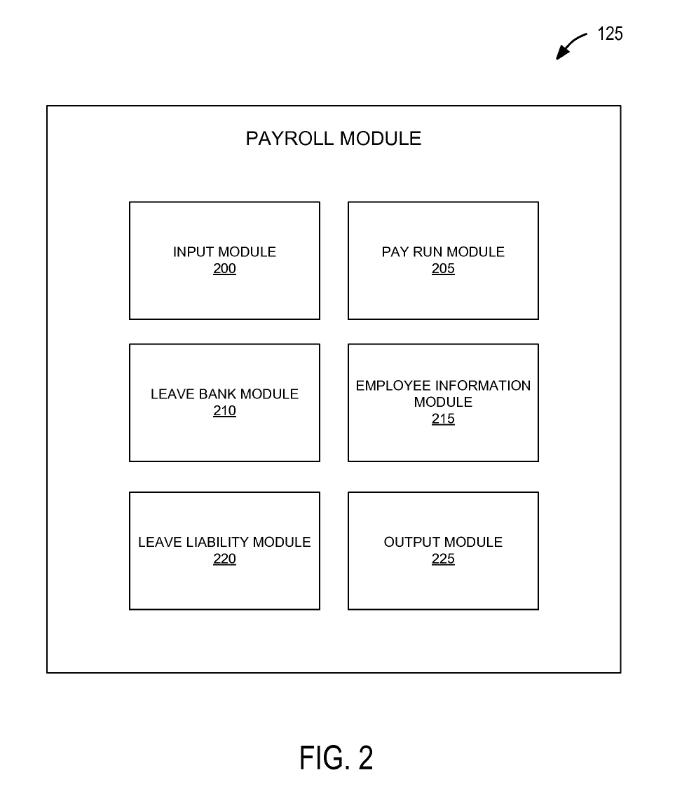

FIG. 2 is a block diagram showing example components of a payroll module 125. The payroll module 125 may include an input module 205, a leave bank module 210, an employee information module 215, a leave liability module 220, and an output module 225. The components of the payroll module 125 are integrated such that an addition, deletion, and/or modification of data in a particular component may result in a corresponding automatic adjustment of data in other components of the payroll module 125, if applicable. For example, a modification to the amount of leave available to a particular employee may result in an automatic adjustment of the leave liability for that particular employee in accordance with the modification of the leave amount.

The input module 205 may be a hardware-implemented module that may receive user inputs relating to management and control of payroll data. For example, the input module 205 may receive user inputs relating to changes in a pay rate for an employee, an addition or deduction of an amount of leave for an employee, and the like.

The leave bank module 210 may be a hardware-implemented module that may manage, control, store, and access data associated with an amount of leave available to employees of a business organization. For example, the leave bank module 210 may manage leave balances for employees, automatically control additions or deductions in leave, and the like.

The employee information module 215 may be a hardware-implemented module that may manage, control, store, and access any suitable information related to one or more employees of a business organization. For example, the employee information module 215 may manage employee information, such as pay rates, start dates, and the like.

The leave liability module 220 may be a hardware-implemented module that may manage, control, calculate, determine, and provide leave liability data associated with one or more employees of a business organization. For example, the leave liability module 220 may manage calculations of leave liability, including calculating and adjusting any changes in leave liability (e.g., changes based on errors in previous data).

The output module 225 may be a hardware-implemented module that may control and send data to the general ledger module 120 and/or to the client device 105. For example, the output module 225 may send display data to the client device 105 to display payroll-related data, and/or the output module 225 may send leave liability data to the general ledger module 120.

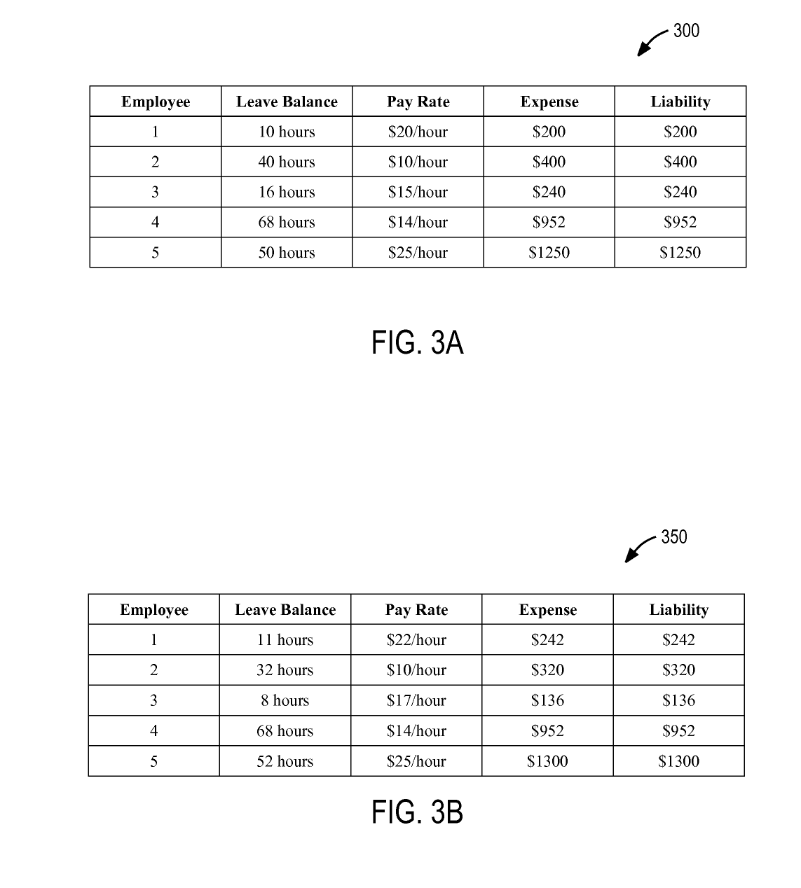

FIGS. 3A and 3B are tables showing example data used to calculate leave liability. The table 300 of FIG. 3A is managed by the leave liability module 220 of FIG. 2 and shows the leave liability calculation at a particular date for employees 1-5. For example, the table 300 of FIG. 3A may show the leave liability for employees 1-5 as of Jan. 1, 2014 based on each employee's pay rate as of Jan. 1, 2014. The leave balance for each employee may be accessed by the leave bank module 210 of FIG. 2 and may be updated automatically based on any changes to the data managed by the leave bank module 210. The pay rate for each employee may be accessed by the employee information module 215 of FIG. 2 and may be updated automatically based on any changes to the data managed by the employee information module 215. The expense and the liability for the leave balance available to each employee may be calculated based on each employee's pay rate as of Jan. 1, 2014. The sum of the leave liabilities for each employee may be totaled and sent to the general ledger module 120 of FIG. 1 as a journal entry reflecting the leave liability as of Jan. 1, 2014. For example, the journal entry to be sent to the general ledger module 120 may reflect a leave liability of $3042 ($200+$400+$240+$952+$1250) for employees 1-5 as of Jan. 1, 2014.

In some embodiments, leave liability journal entries may be sent to the general ledger module 120 periodically. For example, the journal entries may be sent for each pay period for employees.

In some embodiments, if data in the table shown in FIG. 3A is to be changed for any reason (e.g., an addition or deletion in hours made by the leave bank module 210, an adjustment to the employee pay rate made by the employee information module 215, etc.), the change may be automatically reflected in the table of FIG. 3A, which may result in a change to the total sent to the general ledger module 120.

The table 350 of FIG. 3B shows the leave liability calculation for another date for employees 1-5. For example, the table 350 of FIG. 3B may show the leave liability calculated for employees 1-5 as of Jan. 15, 2014. The table 350 shows leave balances for employees 1-5 as of Jan. 15, 2014. The leave balances for each employee may have changed from the leave balances in table 300 of FIG. 3A for any reasons (e.g., additional accrued hours received, leave taken by an employee, etc.). The table 350 also shows the pay rate for each employee as of Jan. 15, 2014. The pay rates for employees may have changed from the pay rates in table 300 of FIG. 3B for any reasons (e.g., a raise received by an employee). The expense and the liability for the leave balance available to each employee may be calculated based on each employee's pay rate as of Jan. 15, 2014. The sum of the leave liabilities for each employee may be totaled, and an adjustment may be sent to the general ledger module 120 of FIG. 1 as a journal entry reflecting the leave liability as of Jan. 15, 2014. The adjustment may be one or more journal entries that reflect the difference between the previous leave liability journal entry and the current leave liability journal entry calculated. For example, a leave liability of $2950 ($242+$320+$136+$952+$1300) for employees 1-5 as of Jan. 15, 2014 may be calculated. In order to accurately reflect a current leave liability in the general ledger, an adjustment based on the current and the previous leave liabilities may be determined and sent to the general ledger as a journal entry. For example, to reflect the leave liability of Jan. 15, 2014, the leave liability module 220 may create two journal entries to be sent to the general ledger: 1) a journal entry subtracting the leave liability posted for Jan. 1, 2014 (e.g., −$3042), and 2) a journal entry adding the leave liability calculated for Jan. 15, 2014 (e.g., +$2950). In another example, the leave liability module 220 may calculate the difference between the Jan. 15, 2014 leave liability ($2950) and the Jan. 1, 2014 leave liability ($3042), and use the difference (−$92) as the journal entry associated with the Jan. 15, 2014 leave liability.

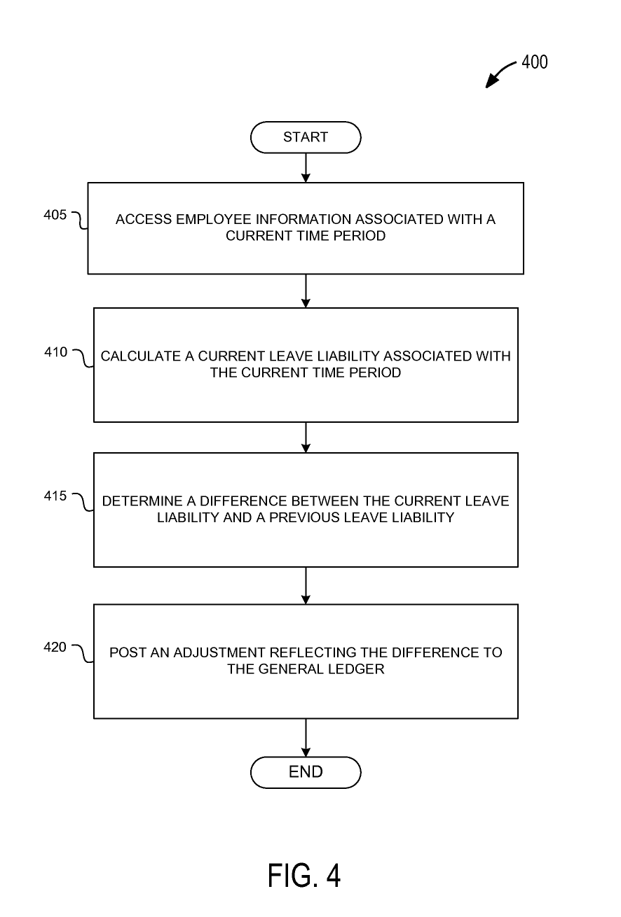

FIG. 4 is a flowchart of an example method 400 for automatic accounting of leave liability. In operation 405, the hardware-implemented employee information module 215 and/or the leave bank module 210 accesses information associated with a first time period. The information that is accessed may relate to a pay rate and/or a leave balance of an employee.

In operation 410, the hardware-implemented leave liability module 220 calculates a first leave liability associated with the first time period using the information accessed in operation 405. For example, the first leave liability may be calculated based on an employee's pay rate and the employee's available leave on Jan. 15, 2014, as reflected for Employee 1 in the table shown in FIG. 3B.

In operation 415, the hardware-implemented leave liability module 220 may determine a difference between the first leave liability and a previous leave liability posted to the general ledger. Using the examples shown in the tables of FIGS. 3A and 3B, a difference between the leave liability for Employee 1 from Jan. 1, 2014 to Jan. 15, 2014 may be determined (e.g., +$42 difference).

In operation 420, the hardware-implemented output module 225 may post an adjustment reflecting the difference to the general ledger. In some embodiments, posting the adjustment may include subtracting the previous leave liability and adding the current leave liability calculated. In some embodiments, posting the adjustment may include posting the difference between the previous leave liability and the current leave liability.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

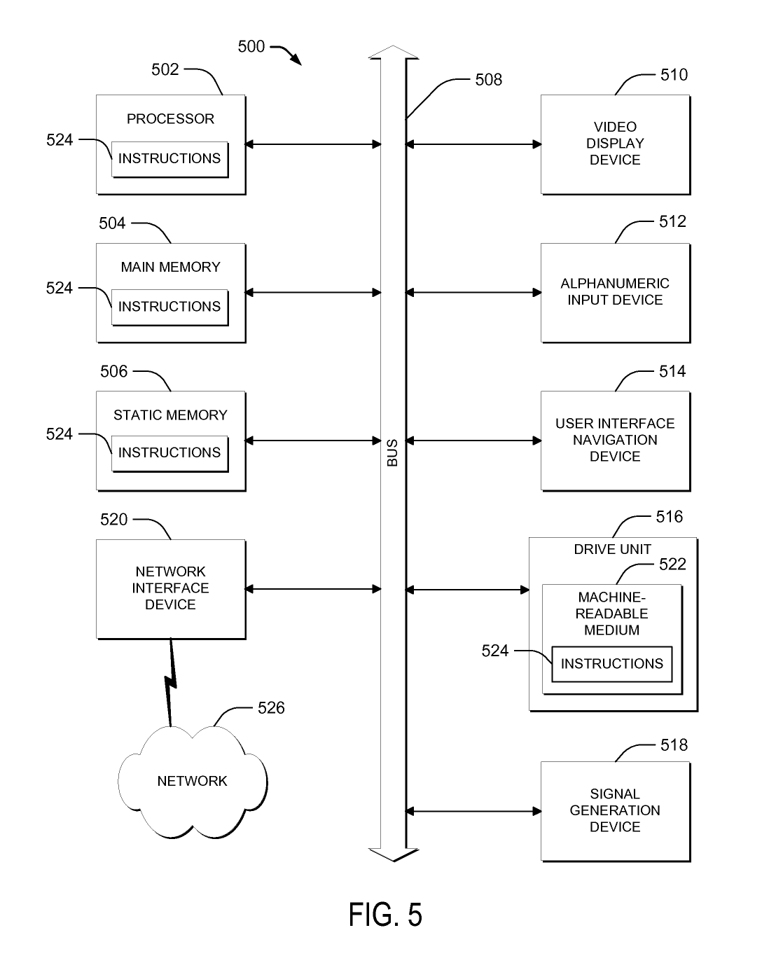

FIG. 5 is a block diagram of a machine in the example form of a computer system 500 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 500 includes a processor 502 (e.g., a central processing unit (CPU), a graphics processing unit (GPU) or both), a main memory 504, and a static memory 506, which communicate with each other via a bus 508. Computer system 500 may further include a video display device 510 (e.g., a liquid crystal display (LCD) or a cathode ray tube (CRT)). Computer system 500 also includes an alphanumeric input device 512 (e.g., a keyboard), a user interface (UI) navigation device 514 (e.g., a mouse or touch sensitive display), a disk drive unit 516, a signal generation device 518 (e.g., a speaker) and a network interface device 520.

Disk drive unit 516 includes a machine-readable medium 522 on which is stored one or more sets of instructions and data structures (e.g., software) 524 embodying or utilized by any one or more of the methodologies or functions described herein. Instructions 524 may also reside, completely or at least partially, within main memory 504, within static memory 506, and/or within processor 502 during execution thereof by computer system 500, main memory 504 and processor 502 also constituting machine-readable media.

While machine-readable medium 522 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present technology, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

Instructions 524 may further be transmitted or received over a communications network 526 using a transmission medium. Instructions 524 may be transmitted using network interface device 520 and any one of a number of well-known transfer protocols (e.g., HTTP). Examples of communication networks include a local area network (“LAN”), a wide area network (“WAN”), the Internet, mobile telephone networks, plain old telephone (POTS) networks, and wireless data networks (e.g., WiFi and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the technology. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
accessing employee information for each employee of a plurality of employees from a data table, the employee information being associated with a first time period, the employee information relating to a paid time off balance of said employee;
calculating, by a payroll server, a first leave liability associated with the plurality of employees and the first time period;
determining, by the payroll server, a difference between the first leave liability and a previous leave liability posted to a general ledger in communication with the payroll server, the previous leave liability being associated with the plurality of employees and a previous time period; and
posting, to the general ledger, an adjustment reflecting the difference between the first leave liability and the previous leave liability.

2. The method of claim 1, wherein posting the adjustment to the general ledger comprises posting the difference between the first leave liability and the previous leave liability.

3. The method of claim 1, wherein posting the adjustment to the general ledger comprises:
posting a negative value of the previous leave liability to the general ledger; and
posting the first leave liability to the general ledger.

4. The method of claim 1, wherein the first leave liability is calculated based on a paid time off balance of each employee of the plurality of employees and a pay rate of each employee of the plurality of employees.

5. The method of claim 4, wherein the adjustment reflects a change in the paid time off balance of an employee of the plurality of employees from the previous time period to the first time period.

6. The method of claim 4, wherein the adjustment reflects a change in the pay rate of an employee of the plurality of employees from the previous time period to the first time period.

7. The method of claim 1, wherein the calculating is in response to a change in the pay rate of an employee of the plurality of employees from the previous time period to the first time period.

8. A system comprising:
a hardware-implemented information module configured to access, from a data table, employee information for each employee of a plurality of employees, the employee information being associated with a first time period, the employee information relating to a first paid time off balance of said employee;
a hardware-implemented leave liability module configured to:
calculate a first leave liability associated with the first time period using the employee information, the first leave liability being a first value relating to the first paid time off balance; and
determine a difference between the first leave liability and a previous leave liability posted to a general ledger in communication with the payroll server, the previous leave liability being a previous value relating to a previous paid time off balance associated with a previous time period; and
a hardware-implemented output module configured to post, to the general ledger, an adjustment reflecting the difference between the first leave liability and the previous leave liability.

9. The system of claim 8, wherein posting the adjustment to the general ledger comprises posting the difference between the first leave liability and the previous leave liability.

10. The system of claim 8, wherein posting the adjustment to the general ledger comprises:
posting a negative value of the previous leave liability to the general ledger; and
posting the first leave liability to the general ledger.

11. The system of claim 8, wherein the first leave liability is calculated based on a paid time off balance of each employee of the plurality of employees and a pay rate of each employee of the plurality of employees.

12. The system of claim 11, wherein the adjustment reflects a change in the paid time off balance of an employee of the plurality of employees from the previous time period to the first time period.

13. The system of claim 11, wherein the adjustment reflects a change in the pay rate of an employee of the plurality of employees from the previous time period to the first time period.

14. The system of claim 8, wherein the calculating of the hardware-configured leave liability module calculates in response to a change in the pay rate of an employee of the plurality of employees from the previous time period to the first time period.

15. A non-transitory machine-readable storage medium storing instructions which, when executed by one or more processors, cause the one or more processors to perform operations comprising:
accessing, from a data table, employee information for each employee of a plurality of employees, the employee information being associated with a first time period, the employee information relating to a first paid time off balance of said employee;
calculating a first leave liability associated with the plurality of employees and the first time period;
determining a difference between the first leave liability and a previous leave liability posted to a general ledger in communication with the payroll server, the previous leave liability being associated with the plurality of employees and a previous time period; and
posting, to the general ledger, an adjustment reflecting the difference between the first leave liability and the previous leave liability.

16. The non-transitory machine-readable storage medium of claim 15, wherein posting the adjustment to the general ledger comprises posting the difference between the first leave liability and the previous leave liability.

17. The non-transitory machine-readable storage medium of claim 15, wherein posting the adjustment to the general ledger comprises:
posting a negative value of the previous leave liability to the general ledger; and
posting the first leave liability to the general ledger.

18. The non-transitory machine-readable storage medium of claim 15, wherein the first leave liability is calculated based on a paid time off balance of each employee of the plurality of employees and a pay rate of each employee of the plurality of employees.

19. The non-transitory machine-readable storage medium of claim 18, wherein the adjustment reflects a change in the paid time off balance of an employee of the plurality of employees from the previous time period to the first time period.

20. The non-transitory machine-readable storage medium of claim 18, wherein the adjustment reflects a change in the pay rate of an employee of the plurality of employees from the previous time period to the first time period.
